(19) United States
(12) Patent Application Publication
(10) Pub. No.: US 2006/0223593 A1
(43) Pub. Date: Oct. 5, 2006

(54) Content delivery system and method for a mobile communication device

(75) Inventor: Lando Noam Ishak, Hod-Hasharon (IL)

Correspondence Address: F. JASON FAR-HADIAN;CENTURY IP LAW GROUP, PO BOX 7333, NEWPORT BEACH, CA, 92658-7333, US

(73) Assignee: IXI Mobile (R&D) Ltd.

(21) Appl. No.: 11/097,645

(22) Filed: Apr. 1, 2005

(51) Int. Cl. H04Q 7/20

(52) U.S. Cl. 455/574

(57) ABSTRACT

A method of content transmission to a mobile device in a mobile communication network is provided. The method comprises determining whether the mobile device is in a first mode; delivering real-time content to the mobile device while the mobile device is in the first mode; and discontinuing delivery of real-time content if the mobile device is in a second mode.

### BACKGROUND

1. Field of Invention

The present invention relates generally to mobile communication services and, more particularly, to a system and method for delivery of content to a mobile communication device in a manner that reduces power consumption.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

Mobile communication devices such as cellular phones and personal digital assistants (PDAs) are generally battery operated and have limited storage and display features. Despite recent improvements in battery life and data storage technologies, it is still quite important to manage the operation of a mobile device and its data storage resources such that the battery life and free storage space are maximized. This is particularly important as mobile devices are operated to handle a great variety of tasks that go beyond mere voice communications.

Particularly, many mobile devices can be configured to receive real-time or non-real time data from content providers or server systems connected to the wireless communication network over which the voice signal is transmitted. Examples of such content include audio/video data streams, text messages, emails, or other information such as stock quotes, weather information, news, etc.

If a user has configured the mobile device to receive all such data as the data becomes available (i.e., in real-time), then it is conceivable that the mobile device will receive a substantial number of data transmissions and messages every time the related information is changed (e.g., consider the price ticker for a stock exchange that is continuously updated). This can result in substantial traffic being directed to the mobile device.

As most of said data and messages are generated in real-time, it is likely for the mobile device to receive the respective content in random intervals. Each time the mobile device receives a new content, the mobile device will wake up from power conservation mode to process the received content. When the content is received frequently, the mobile device will therefore have to wake up frequently. In the case of stock quotes, for example, it can be imagined that the mobile device will rarely remain in the power conservation mode, due to the perpetual changes in the stock market prices.

Even further, since a large volume of data is being transmitted to report the new content and information, the mobile device's storage resources will be easily inundated, unless a powerful data management and garbage collection mechanism is utilized to remove the outdated data as the new data arrives. Since a user does not exclusively or continuously rely on a mobile device to receive such information, the real-time receipt or storage of such content as it becomes available is unnecessary.

Most real-time content, such as a television or radio audio/visual stream or stock quotes, are not useful if the user is not actively viewing or listening to the information. Storing such information is also not a good option due to the limited storage capacity of mobile devices and as new information will replace the old information.

Therefore, the receipt or storage of such real-time data while the user is not using the device is unnecessary and a strain on the battery, storage capacity, and other resources of the mobile device. When the real-time delivery of information is not important to the user, this case is even more obvious.

Thus, a method or system is needed that can determine the proper timing for providing the user with the needed content.

### SUMMARY

The present disclosure is directed to a system and corresponding methods that facilitate the optimization of battery life for a mobile communication device by forwarding content to the mobile device in instances that a user is actively utilizing the mobile device. In certain embodiments, content is either queued or forwarded in real-time to the mobile device when it is determined that the mobile device is in an active state.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method of content transmission to a mobile device in a mobile communication network is provided. The method comprises determining whether the mobile device is in a first mode and delivering real-time content to the mobile device while the mobile device is in the first mode. Delivery of real-time content is discontinued, if the mobile device is in a second mode.

The first mode is an active mode and the second mode is an inactive mode. The determination of whether the mobile device is in the first mode can be performed based on status information sent from the mobile device, wherein the status information can be in predetermined time intervals.

The status information comprises information about whether the mobile device is in the first mode or the second mode. Thus, the discontinuation of the real-time content delivery can be performed based on status information sent from the mobile device.

In accordance with another embodiment, a method of content transmission to a mobile device in a mobile communication network comprises determining whether the mobile device is in a first mode; receiving real-time content to the mobile device while the mobile device is in the first mode; and discontinuing receipt of real-time content if the mobile device is in a second mode.

The status information, in one embodiment, can be based on at least one of whether a user has interacted with the mobile device's user interface during a threshold period, whether the mobile device's cover is in an open position, and whether the mobile device's illumination unit is turned on. The discontinuation of the receipt of real-time content can be performed based on status information sent from the mobile device.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communications environment, in accordance with one or more embodiments of the invention;

FIG. 2 is a flow diagram of a method for delivery of content to a mobile device, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide a method and system for optimizing power consumption in a mobile communication device by transmitting content to the mobile communication device based on whether or not the device is in an active status.

Electronic services, services, and online services are used interchangeably herein. The services provided by the system of this invention, in one or more embodiments, are provided by a content provider. A content provider is an entity that operates and maintains the computing systems and environment, such as server systems and infrastructures that enable the delivery of information. Typically, server architecture includes components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

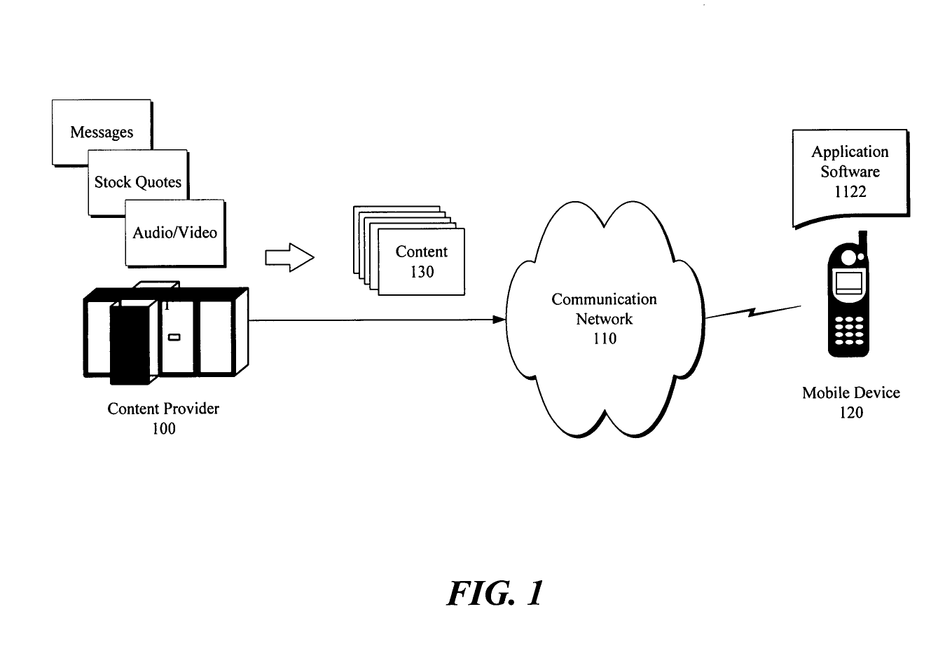

Referring to the drawings, FIG. 1 illustrates an exemplary communications environment in which the system of the present invention may operate. In accordance with one aspect of the system, the system environment comprises a content provider 100, a communication network 110, and a mobile device 120. The content provider 100 and mobile device 120 are connected by way of the communication network 10. The terms “connected,” “coupled,” or any variant thereof, mean any connection or coupling, either direct or indirect, between two or more elements. The coupling or connection between the elements can be physical, logical, or a combination thereof.

In one embodiment, the communication network 10 provides the medium and infrastructure for transmitting digital or analog signals between content provider 100 and mobile device 120. In certain embodiments, mobile device 120 is a cellular telephone and communication network 110 is a wireless telephone network, for example. Mobile device 120, content provider 100 and communication network 110, however, may be implemented over any type of mobile, fixed, wired or wireless communication technology (e.g., landline telephony, cellular, radio, radar, infrared, etc.).

One of ordinary skill in the art will appreciate that communication network 110 may advantageously be comprised of one or a combination of various types of networks without detracting from the scope of the invention. Such networks can, for example, comprise personal area networks (PANs), local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications networks that can provide a means of communication between mobile device 120 and content provider 100.

In some embodiments, communication network 110 can be a part of the world wide web (i.e., the Internet). The Internet, in a well-known manner, connects millions of computers world wide through standard common addressing systems and communications protocols (e.g., Transmission Control Protocol/Internet Protocol (TCP/IP), HyperText Transport Protocol) creating a vast communications network.

In either context, mobile device 120 can communicate with content provider 100 to send and receive electronic packets of information, in form of electronic requests and responses. In a particular embodiment, the packets are constructed to comprise information about the status of mobile device 120. That is, certain packets communicated from mobile device 120 include information in form of data bits that indicate whether mobile device 120 is in an active or inactive status.

The operational status of mobile device 120 can be determined, depending on implementation, in several different manners. For example, if mobile device 120 is a clamshell type phone, or includes a flip cover, then when the mobile device 120 or the cover is in an open position, it is assumed that mobile device 120 is in an active status. Thus, a user can view or hear information transmitted to mobile device 120.

In another embodiment, an active status is determined when a user interacts with a user interface of mobile device 120 or while a predetermined amount of time has lapsed after the user's last interaction with a user interface of mobile device 120. In yet another embodiment, an active status is determined if a backlight of mobile device 120 is illuminated. In some embodiment, a motion sensor or other sensing mechanism may be included in mobile device 120 to determine if mobile device 120 is in an active or inactive status.

Accordingly, in one embodiment, content provider 100 receives status information from mobile device 120 to determine if content 130 should be downloaded to mobile device 120, when mobile device 120 is in an active mode. In certain embodiments, content provider 100 is a backend server that forwards content 130 to a phone number or network address (e.g., IP address) associated with mobile device 120.

Content provider 100 can download to mobile device 120 various forms of content 130, in accordance with various aspects of the system. For example, the content 130 may comprise text messages, emails, images, voice, streaming audio/video, stock quotes, weather information and other data services that may be supported and delivered to a mobile device 120 by content provider 100.

In one embodiment, content provider 100 is a wireless communications content provider (e.g., Sprint, AT&T, Verizon, etc.) that can track the active status of devices connected to communication network 110. For example, content provider 100 may comprise America On Line (AOL)™, Microsoft Network (MSN)™ and Yahoo™. Depending on implementation, in one embodiment, content provider 100 receives information about the active status of mobile device 120 either directly from mobile 120 or from another device connected thereto.

In an exemplary embodiment, mobile device 120 periodically sends a status update to content provider 100. That is, if the status of mobile device 120 changes from active to inactive, for example, this change of status is reported to content provider 100 by way of a notification message. For example, this status update procedure may be implemented by sending a first notification message when mobile device 120 becomes active, and sending a second notification message when mobile device 120 becomes inactive.

In certain embodiments, when mobile device 120 is in an active state it sends a notification message in predetermined time intervals to indicate that it has maintained an active status. If content provider 100 does not receive a notification to that effect, then content provider 100 discontinues transmission of content to mobile device 120. Other notification implementations may be possible. For example, a content provider may continue downloading information to mobile device 120 unless it receives a non-active status notification message in predetermined time intervals.

In some embodiments, content provider 100 forwards one or more messages to mobile device 120 based on occurrence of certain events in real-time. For example, a user may subscribe to a financial, news, or sports broadcasting service which would forward a message to mobile device 120 in response to a stock price change, a heightened security level, or a game's score result respectively, if the mobile status is in an active state, or alternatively wait to transmit said information until the service receives a notification message that mobile device 120 has become active.

To manage the timing and frequency with which content is forwarded to mobile device 120, application software 1122 is installed or executed on one of mobile device 120, content provider 100, a third party portal, or a combination of said systems. As used herein, the terms mobile device, third party portal, content provider and communication network are to be viewed as designations of one or more computing environments that comprise application, client or server software for servicing requests submitted by respective software included in devices or other computing systems connected there to. These terms are not to be otherwise limiting in any manner. The application software, for example, may be comprised of one or more modules that execute on one or more computing systems, as described in further detail below.

In accordance with one aspect of the invention, application software 1122 is implemented to monitor status update notifications that are communicated between mobile device 120 and content provider 100. Application software 1122 monitors the active status of mobile device 120 by determining whether mobile device 120 is in active or inactive status. For example, when mobile device 120's backlight is switched from off to on, or when a user presses a key on mobile device 120's keypad, application software 1122 determines that mobile device 120 is in active status, and reports the change of status by way of a notification message to content provider 100.

Upon receipt of the notification of active status, content provider 100 forwards any data queued for delivery or newly generated data to mobile device 120 in real-time. On the other hand, if application software 1122 determines that a time period has passed since a user has interacted with mobile device 120's user interface, or if the backlight of mobile device 120 is changed from on to off, for example, then a non-active status notification is generated and forwarded to content provider 100 to request content provider 100 discontinue transmitting content to mobile device 120.

It is noteworthy that the present invention is to be distinguished from a scenario when communication to a mobile device is interrupted or discontinued due to the mobile device being turned off. In accordance with one or more embodiments of the invention, mobile device 120 may be in an “inactive status” even when mobile device 120 is on. Thus, various test parameters are used to determine if the user is not interacting with mobile device 120 (i.e., whether mobile device 120 is in active or inactive status).

The above parameters may be based on duration of time the user has not interacted with a user interface of mobile device 120, the duration of time or whether an illumination unit of mobile device 120 has been off, whether mobile device 120 is in open or close position, whether mobile device 120 is in motion, and other similar change of status indicators that can be used to predict if a user is actively using mobile device 120 or at least has it within the user's audio/visual sight.

In certain embodiments, application software 1122 may be utilized by a user to apply or adjust a delay threshold associated with a change of status indicator, such that a change in one status parameter does not trigger a status notification message to be forwarded to content provider 100. For example, a use may quickly open and close mobile device 120's cover, or accidentally press a button on its keypad.

Using a delay threshold, application software 1122 waits for another change of status indicator to be detected before sending a notification message. In this manner, accidental or minimal user interaction with mobile device 120 does not trigger content provider 100 to download data to mobile device 120. In one embodiment, if the user does not set the delay threshold, then a default value may be assigned automatically by content provider 100, application software 1122, or mobile device 120's manufacturer.

It should be noted that the above exemplary embodiments are not to be construed to limit the scope of the invention to a singular content provider 100, or application software 1122 that executes exclusively on the mobile device 120, or a change of status notification method that is limited to the examples provided above.

As noted above, application software 1122 may be implemented on a device or a system other than mobile device 120. For example, application software 1122 or its components may be implemented, installed, and executed either in a singular or a distributed environment. That is, certain components of the application software may be installed and executed on mobile device 120, while other components may be executed and installed on a third party portal, one or more content providers 100, or other systems attached thereto.

The change of status notification method of this invention may be also implemented based on other factors that can be used to determine user interaction, such as level of light or acoustic waves surrounding mobile device 120, a break in an optical sensor circuit, etc. Furthermore, in certain embodiments, mobile device 120 may selectively request that content of certain type to be subject to delayed transmission, while other content types to be forwarded in real-time. For example, a user may select to receive traffic related information in real-time and weather related information only at a specific time during the day.

As such, application software 1122, in one embodiment, supports a system for allocating different delay thresholds or transmission times for different types of content. For example, finance related events (e.g., change in stock prices) may be set to be received at 6.00 AM, traffic related information may be set to be received at 6.00 PM, and important news related events (e.g., heightened security alerts) may be set to be received in real-time.

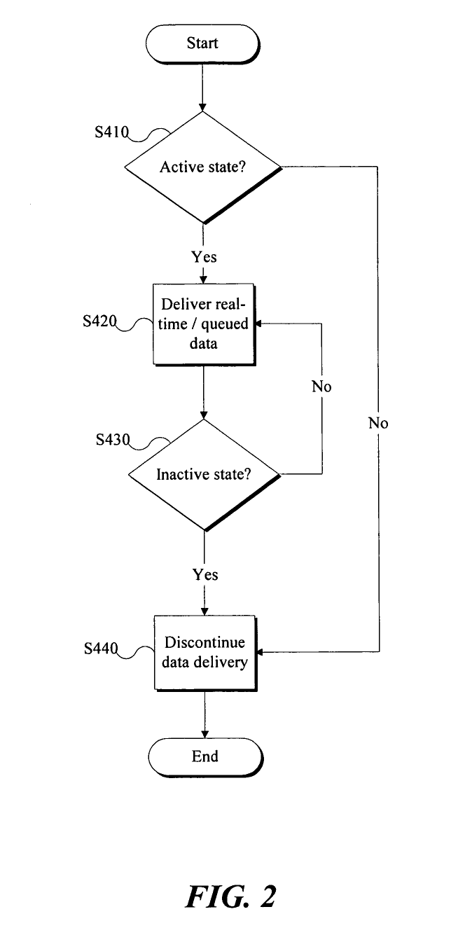

Referring to FIGS. 1 and 2, in accordance with one aspect of the invention, application software 1122 or a component thereof is executed on content provider 100 or mobile device 120 to determine if mobile device 120 is in an active state (S410). If mobile device 120 is in an active state, application software 1122 executed on mobile device 120 transmits one or more notification messages to content provider 100 requesting content 130.

While mobile device 120 is in an active state, and when the requested content 130 is available, service provide 100 continues to transmit content 130 to mobile device 120 in real-time (S420). That is, as soon as content 130 is ready for delivery to mobile device 120, content 130 is transmitted to mobile device 120. In certain embodiments, content 130 may be queued in a storage space on content provider 100, for example, if mobile device 120 is not in an active state. In such scenario, queued content 130 is transmitted to mobile device 120, when application software 1122 reports to content provider 100 that mobile device 120 has become active.

If application software 1122 determines that mobile device 120 is in an inactive state (S430), then a change of status notification is forwarded to content provider 100 to discontinue delivery of content 130 data to mobile device 120. The data delivery is later reinstated when application software 1122 determines that mobile device 120 has become active again (S410). In one embodiment, delivery of content 130 continues from the last position where data delivery had terminated.

That is, if a first section of the data was transmitted prior to mobile device 120 going inactive, then the second portion of the data immediately following the first portion is transmitted, as soon as application software 1122 detects that mobile device 120 has become active. In this embodiment, the data that is generated while mobile device 120 has been inactive is queued and then transmitted as soon as mobile device 120 becomes active.

In other embodiments, content is not queued while mobile device 120 is in an inactive state. That is, data that would have been transmitted to mobile device 120 had it remained in the active state is lost. This is typical of content delivery systems, such as streaming audio/video (e.g., radio, television, etc.) wherein the content is being broadcasted in real-time or where content data is constantly changing (e.g., stock market quotes).

Accordingly, some types of content 130 (e.g., email messages) are queued and other types of content 130 (e.g., stock quotes) are not. The above approach in delivering content 130 to mobile device 120 when it is determined to be in an active state advantageously allows mobile device 120 to remain in a power saving mode for a longer period of time because mobile device 120 will be no longer woken up at random intervals to process content 130 transmitted to it in real-time. Thus, mobile device 120 receives content from content provider 100 when certain conditions indicating the active status of mobile device 120 occur, as discussed earlier.

In one embodiment, mobile device 120 continues to receive content 130 while in active mode until a threshold time period has passed during which conditions triggering active status of mobile device 120 are not detected by application software 1122. After the threshold time has expired, or in some embodiments in response to a user interaction (i.e., direct input), mobile device 120 switches to power saving mode (i.e., sleep mode) until a next condition triggering active status is detected.

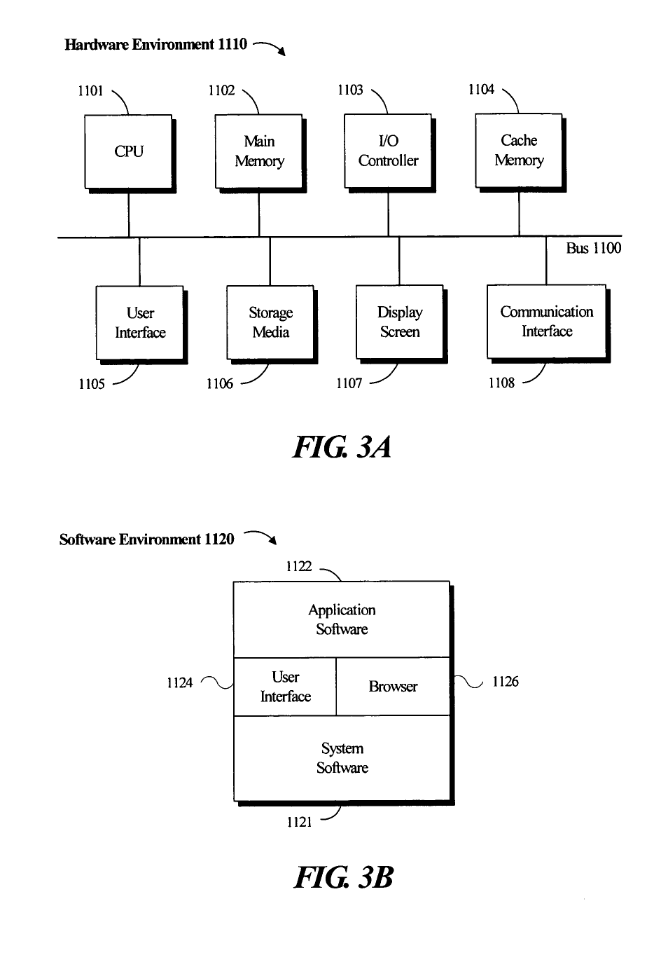

In one or more embodiments of the system, content provider 100, communication network 110, and mobile device 120 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments.

Software environment 1120 is divided into two major classes comprising system software 1121 and application software 1122. System software 1121 comprises control programs, such as the operating system (OS) and information management systems that instruct the hardware how to function and process information.

Application software 1122 is a program that performs a specific task. In embodiments of the invention, system and application software are implemented and executed on one or more hardware environments to accommodate the transmission of real time content 130, for example, to mobile device 120 in accordance with mobile device 120's active or inactive status.

Referring to FIG. 3A, an embodiment of application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a modem, or an integrated services digital network (ISDN) card, etc.), and a system synchronizer (e.g., a clock).

Processor 1101 may or may not include cache memory 1104 utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in certain embodiments of the system mobile device 120 may be a PMG phone or equivalent.

In one or more embodiments, communication interface 1108 can send and receive electrical, electromagnetic, or optical signals that carry digital data streams representing various types of information including program code. If communication is established via the Internet, hardware environment 1110 may transmit program code through an Internet connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software such as an operating system that controls the low-level operations of hardware environment 1110. Low-level operations comprise the management of the system's resources such as memory allocation, file swapping, and other core computing tasks. In one or more embodiments of the invention, the operating system comprises at least one of Symbian, Nucleus, Microsoft Windows, Palm, or Macintosh operating systems. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1, for example, in one embodiment of the invention, client software is executed on mobile device 120 and server software is executed on content provider 100.

Software environment 1120 may also comprise web browser software 1126 for communicating with the Internet. Further, software environment 1120 may comprise a user interface 1124 (e.g., a Graphical User Interface (GUI)) for receiving user commands and data. The commands and data received are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate optimizing power consumption in a mobile device. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise in the present disclosure.

The method of the present invention may be performed in either hardware, software, or any combination thereof. In particular, the present method may be carried out by software, firmware, or macrocode operating on a computer or computers of any type. Additionally, software embodying the present invention may comprise computer instructions and be stored in a recording medium (e.g., memory stick, ROM, RAM, magnetic media, punched tape or card, compact disk (CD), DVD, etc.). Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of content transmission to a mobile device in a mobile communication network, the method comprising:
determining whether the mobile device is in a first mode;
delivering real-time content to the mobile device while the mobile device is in the first mode; and
discontinuing delivery of real-time content if the mobile device is in a second mode,
wherein the first mode is distinguished from the second mode based on at least one of length of user interaction with the mobile device to perform one or more functions and degree with which a power source of the mobile device is utilized.

2. The method of claim 1, wherein the first mode is an active mode.

3. The method of claim 1, wherein the second mode is an inactive mode.

4. The method of claim 1, wherein the determining is performed based on status information sent from the mobile device.

5. The method of claim 4, wherein the status information comprises information about whether the mobile device is in the first mode.

6. The method of claim 4, wherein the status information comprises information about whether the mobile device is in the second mode.

7. The method of claim 1, wherein the discontinuing is performed based on status information sent from the mobile device.

8. The method of claim 7, wherein the status information comprises information about whether the mobile device is in the first mode.

9. The method of claim 7, wherein the status information comprises information about whether the mobile device is in the second mode.

10. The method of claim 4, wherein the status information is sent from the mobile device in predetermined time intervals.

11. A method of content transmission to a mobile device in a mobile communication network, the method comprising:
determining whether the mobile device is in a first mode;
receiving real-time content while the mobile device is in the first mode; and
discontinuing receipt of real-time content if the mobile device is in a second mode,
wherein the first mode is distinguished from the second mode based on at least one of length of user interaction with the mobile device to perform one or more functions and degree with which a power source of the mobile device is utilized.

12. The method of claim 11, wherein the first mode is an active mode.

13. The method of claim 11, wherein the second mode is an inactive mode.

14. The method of claim 11, wherein the determining is performed based on status information of the mobile device.

15. The method of claim 14, wherein the status information comprises information about whether the mobile device is in the first mode.

16. The method of claim 14, wherein the status information comprises information about whether the mobile device is in the second mode.

17. The method of claim 11, wherein the discontinuing is performed based on status information of the mobile device.

18. The method of claim 17, wherein the status information comprises information about whether the mobile device is in the first mode.

19. The method of claim 17, wherein the status information comprises information about whether the mobile device is in the second mode.

20. The method of claim 14, wherein the status information is based on at least one of whether a user has interacted with the mobile device's user interface during a threshold period, whether the mobile device's cover is in an open position, and whether the mobile device's illumination unit is turned on.
